(19) United States
(12) Patent Application Publication
(10) Pub. No.: US 2007/0029699 A1
(43) Pub. Date: Feb. 8, 2007

(54) Binding resin, particularly for building and transportation, method for preparing the same, and articles obtainable with the resin

(76) Inventor: Oscar Lucini, Saronno (IT)

Correspondence Address: Modiano & Associati, Via Meravigli 16, Milano, 20123, IT

(21) Appl. No.: 10/577,272

(22) PCT Filed: Jun. 21, 2004
(86) PCT No.: PCT/EP04/06690

§ 371 Date: Apr. 26, 2006

(51) Int. Cl. B27N 3/08

(52) U.S. Cl. 264/239

(57) ABSTRACT

A binding resin, particularly for manufacturing articles, the method for its preparation, and articles that can be obtained with the resin. The binding resin is obtained by mixing essentially a first powder that comprises silica and one or more hardening agents with a solution of at least one silicate of an alkaline metal. Some of the possible additional ingredients are a powder that comprises at least one pozzolanic inorganic binding agent, at least one pozzolanic binding agent with high specific surface area, and a solution of at least one waterproofer. The addition of the optional ingredients provides additional advantages. The invention also relates to a method for preparing and using the resin and to the products (or articles) that can be obtained from the resin.

### TECHNICAL FIELD

The present invention relates to a binding resin, particularly but not exclusively for manufacturing articles, to the method for preparing said resin, and to articles to be used in various industrial sectors and manufactured starting from said resin.

In many applications in several industrial sectors, such as for example the building, naval and transportation sectors just to mention the most significant examples, there is ever-increasing interest in new materials and products that allow to manufacture articles that have specific properties such as hydrophobicity, fire-retardant properties, low weight and mechanical strength.

### Background Art

Specific protection or proofing materials are known in the pertinent industrial fields.

### DISCLOSURE OF THE INVENTION

The aim of the present invention is to provide a resin particularly for manufacturing articles that can be used in the most disparate technical applications.

An object is to provide a resin particularly for manufacturing articles having excellent waterproofing power and chemical and physical resistance to the most disparate stresses.

Another object is to provide a resin as above that has excellent thermal insulation power and soundproofing power and durable characteristics of particular resistance to high temperatures.

Another object of the present invention is to provide a resin as above that is susceptible to finishing treatments by means of plaster or decorations in the case of applications in the building sector.

Another object is to provide a method for preparing said resin.

Another object is to provide an article manufactured starting from said resin.

This aim and these and other objects are achieved by a binding resin particularly for manufacturing articles, characterized in that it comprises the following components:

(A) a powder that comprises silica and one or more hardening agents; and

(B) a solution of at least one silicate of an alkaline metal.

The aim and objects of the invention are also achieved by a method for producing a binding resin particularly for manufacturing articles, said method being characterized in that it comprises the step of mixing a powder that comprises silica and one or more hardening agents with a solution of at least one silicate of an alkaline metal.

Advantageously, the resin according to the invention further comprises at least one of the following optional ingredients:

(C) a powder that comprises at least one inorganic pozzolanic binding agent;

(D) a powder that comprises at least one pozzolanic binding agent with high specific surface area;

(E) a solution that comprises at least one waterproofer;

(F) a powder that comprises refractory clay and comprises aluminum silicate;

(G) a powder that comprises at least one solid water-repellent agent.

More preferably, the resin according to the invention comprises at least one element for each one of the following groups:

Group (1): (A) a powder comprising silica and one or more hardening agents;

Group (2): (B) a solution of at least one silicate of an alkaline metal;

Group (3):
(C) a powder that comprises at least one inorganic pozzolanic binding agent;
(D) a powder that comprises at least one pozzolanic binding agent with high specific surface area; and
(E) a solution that comprises at least one waterproofer;

Group (4): (F) a powder that comprises refractory clay comprising aluminum silicate; and

Group (5): (G) a powder that comprises at least one water-repellent in solid form.

Even more preferably, the resin according to the invention comprises all ingredients (A) to (G).

According to a preferred embodiment, the method is characterized in that it comprises the additional steps of mixing ingredients (A) and (B) with at least one of the optional ingredients selected from the group that consists of (C), (D), (E), (F), and (G) cited above.

According to a preferred embodiment, the method is characterized in that the solid ingredient (A) is mixed separately with all the optional solid components that are present and are selected from the group that consists of ingredients (C), (D) and (G) and mixtures thereof, mixing separately the liquid component (B) with the other optional liquid component (F), if present, and at a later time mixing the solid components and the liquid ones.

Advantageously, the component (G), if present, is the first of the solid ingredients to be mixed with (A).

According to a particularly advantageous embodiment, in which the resin comprises all the ingredients (A) to (G), the method according to the invention is characterized in that it comprises the steps of:

(a) mixing a powder that comprises silica and one or more hardening agents with a powder that comprises at least one water-repellent agent in solid form;

(a1) mixing the product of step (a) with a powder that comprises at least one pozzolanic inorganic binding agent;

(a2) mixing the product of step (a1) with a powder that comprises at least one pozzolanic binding agent with high specific surface area;

(a3) mixing the product of step (a2) with a powder that comprises refractory clay that comprises aluminum silicate;

(b) mixing a solution of at least one silicate of an alkaline metal with a solution that comprises at least one waterproofer; and

(c) mixing the product of step (a3) with the product of step (b).

A particularly advantageous embodiment of the method according to the invention is characterized in that it comprises the steps of:

(d) mixing the binding resin that comprises components (A) and (B) and optionally at least one component selected from the group that consists of said components (C), (D), (E), (F) and (G), with at least one inert material;

(e) casting the mixture obtained from step (d) into a mold or form;

(f) curing the product.

The term “hardening agent” is used to designate a compound that is capable of producing cross-linking of the environment in which said compound is present. In particular, the structuring produced by cross-linking occurs by virtue of the presence of at least two separate functional groups that are capable of forming between them new chemical bonds, of the ionic type (due to the presence of anionic groups and permanent and/or transient cationic groups) and/or covalent type. Hardening preferably occurs as a consequence of the formation of covalent bonds due to reactions between a nucleophile and an electrophile. According to this preferred case, advantageously the same molecule possesses both the electrophilic functionality and the nucleophilic functionality, so that it is possible to achieve the intended structuring effect by adding a single ingredient. However, it is also possible to use two different classes of molecule, each provided with one of the two reagent groups. The preferred nucleophilic functionalities include for example nucleophilic functionalities, advantageously groups provided with mobile hydrogen as hydroxyl groups, amine groups and organic acids (carboxylic acids and acids containing sulfur or phosphor), polar groups or groups comprising a functionality that can be polarized in particular reaction conditions (for example ester groups and groups comprising double and triple bonds). The preferred electrophilic functionalities include polar or polarizable electrophiles (such as for example groups that comprise double and triple bonds). Particularly preferred hardening agents are selected from the group that comprises esters of polyhydroxyl alcohols, alkylene carbonate esters, and mixtures thereof.

The term “pozzolanic” refers here to substances characterized by chemical affinity with natural pozzolana. In general, these substances are also technically known as “artificial pozzolanas”.

Natural pozzolana is an inorganic material that is predominantly constituted by silica and alumina that are poorly catalyzed or completely amorphous. It is capable of hardening lime, perhaps by virtue of or due to the formation of hydrated calcium silicates.

Among artificial pozzolanas, mention can be made of silica fume, blast furnace slag and fly ash.

The term “pozzolanic inorganic binding agent” is used to designate the product of industrial origin, which is slag from steel processing.

The term “pozzolanic binding agent” with high specific surface area is used to designate the product of the process for reducing quartzite in electric arc furnaces during the production of iron-silicon alloys.

The term “mass or body waterproofer” is used to designate a water-repellent additive or waterproofer in liquid form that comprises alkylsiloxanes in an aqueous solution.

In the present invention, the term “alkyl” and its derivatives are used to designate a saturated hydrocarbon radical with linear or branched or cyclic chain, comprising 1 to 5 carbon atoms. Preferred examples of alkyls are methyl, ethyl, n-propyl, n-butyl, n-pentyl, i-propyl, i-butyl, i-pentyl, t-butyl.

In the present invention, the term “alkoxy” is used to designate an alkyl radical as defined above, attached to the rest of the molecule by means of an oxygen atom.

The suffix “silane” designates here a hydrogenated compound of silicon that has analogies with hydrocarbons, particularly saturated hydrocarbons. In the case of alkyl alkoxysilane, the central silicon atom is substituted with at least one alkyl group defined as above and an alkoxy group defined as above.

The suffix “siloxane” designates a silicone, i.e., an organic synthetic compound comprising oxygen and silicon. The skeleton is constituted by a chain of alternated atoms of silicon and oxygen (optionally also hydrogen) without carbons. The organic residues constitute the substituents of the silicon atoms. The term “alkylsiloxanes” designates compounds in which at least one of the silicon atoms of the main chain is substituted with at least one alkyl group defined as above.

Ways of Carrying out the Invention

In a first aspect, the present invention provides a binding resin particularly for manufacturing articles that essentially comprises the following components: (A) a hardening powder based on silica with the addition of one or more hardening agents, said component being present in an amount between 15 and 85%, preferably between 35 and 50%, by weight on the final weight of the mixture, and (B) a solution of at least one silicate of an alkaline metal, said component being preferably present in an amount between 15 and 85%, preferably between 35 and 50% by weight on the final weight of the mixture.

Advantageously, the resin comprises at least one of the following optional ingredients: (C) a powder that comprises at least one pozzolanic inorganic binding agent, said component being present in an amount between 4 and 10%, preferably between 4 and 6%, even more preferably equal to 4% by weight on the final weight of the mixture; (D) a powder that comprises at least one pozzolanic binding agent with high specific surface area, said component being present in an amount between 5 and 15%, preferably between 6 and 10%, even more preferably equal to 6% by weight on the final weight of the mixture; (E) a solution that comprises at least one waterproofer, said component being preferably present in an amount between 1 and 2%, preferably between 1 and 1.5%, even more preferably equal to 1.3% by weight on the final weight of the mixture, (F) a powder that comprises refractory clay that comprises aluminum silicate, said component being present in an amount between 5 and 40%, preferably between 15 and 25%, even more preferably equal to 20% by weight on the final weight of the mixture, and (G) a powder that comprises at least one water-repellent or waterproof agent in solid form, said component being present in an amount between 0.1 and 1%, preferably between 0.1 and 0.5%, even more preferably equal to 0.1% by weight on the final weight of the mixture.

In the present invention, the component (A), the hardening powder based on silica with the addition of one or more hardening agents, is a powder that preferably comprises 10 to 99.9% by weight of silica in powder, mixed with an amount comprised between 0.1 and 20% by weight on the total of the powder of at least one hardening agent, advantageously selected from the group that comprises esters of polyhydroxyl alcohols and alkylene carbonate esters.

Component (A) has surprisingly allowed to obtain a binding resin that is characterized by good resistance to high temperatures, further performing a binding role in the mixing step of the method according to the invention.

Component (B) is a preferably aqueous solution of a silicate of an alkaline metal, advantageously sodium, potassium or a mixture thereof. Together with component (A), it is the essential ingredient of the described binding resin.

Advantageously, an aqueous solution of alkaline metal silicate has a weight ratio between SiO₂ and Na₂O comprised between 1.5:1 and 4.0:1 or a weight ratio between SiO₂ and K₂O comprised between 1.5:1 and 4.0:1.

Component (B) has surprisingly conferred waterproofing power and resistance to high temperatures to the binding resin and to the final article.

Component (C) acts as a mass additive. A preferred pozzolanic inorganic binding agent of component (C) is blast furnace slag, which is a latent hydraulic material that comprises calcium and silicon oxide (silica), alumina, magnesium oxide and metallic magnesium together with modest or low quantities of other oxides that depend on the natural composition of the minerals and coals used as raw materials.

In particular, a preferred blast furnace slag comprises calcium oxides in an amount of approximately 40% by weight, silica in an amount of approximately 30% by weight, and alumina in an amount of approximately 10% by weight, and optionally comprises traces of other oxides having various chemical types, in which the actual composition and quantities can vary according to the source material from which the slag is derived.

Blast furnace slag usually has the appearance of a powdery gray solid that has a characteristic odor, is not soluble in water but soluble in hydrofluoric acid and has a specific gravity preferably comprised between 2 and 3 g/cm³.

The chemical composition of a preferred furnace slag is TiO₂ (0.33%), MnO (0.55%), S (1.25%), SiO₂ (37.02%), CaO (44.01%), MgO (5.29%), Al₂O₃ (10.92%) and K₂O (0.20%), where all the percentages are expressed by weight.

Component (C) has surprisingly allowed to provide a binding resin that is extremely or highly waterproof and has a very high mechanical strength.

Component (D) has the appearance of a powder that is preferably micronized and amorphous and has spheroidal granules.

In particular, a preferred pozzolanic binding agent with high specific surface area is “silica fume” (also known as “condensed silica fume”), which occurs as an extremely fine powder with an average particle size preferably comprised between 0.02 and 15 microns, a specific surface area preferably comprised between 15 and 40 g/m² (which is approximately 50-60 times the surface area of cement) and an apparent density preferably comprised between 0.30 and 0.35 kg/l.

The main component of condensed silica fume is silicon dioxide (SiO₂), in an amount between 90 and 95% on the total weight of the component.

The chemical composition of a preferred silica fume is SiO₂ (89-92%), Fe₂O₃ (1.10%), MgO (0.95%), SO₃ (0.8%), Na₂O₃ (1.05%), K₂O (0.50%), C (1.8%), LOI (3%) and U.R. (0.8%), where all the percentages are expressed by weight.

The condensed silica fume has a bulk density that is preferably comprised in the range of 0.60+/−0.02 kg/l and a specific surface area preferably equal to, or greater than, 15 m²/g (measured according to the B.E.T. method).

Component (D) has surprisingly improved the qualities of the fresh mixture and of the article after hardening. Its addition in fact unexpectedly led to a fresh mixture that does not produce segregation, exhibits no bleeding, has high thixotropy and cohesive effect, while the hardened mixture has a better chemical resistance, a great reduction in porosity, excellent mechanical strength, and extremely high impermeability to water and oxygen and carbon dioxide.

Component (E) is constituted by a preferably aqueous solution of at least one alkylsiliconate, preferably potassium methylsiliconate, with a dose for use comprised between 1 and 3%, preferably equal to 1.3% by weight on the total weight of the mixture.

Component (E) has surprisingly allowed to obtain mixtures that are compact and waterproof and at the same time has unexpectedly had a plasticizing effect that has allowed to improve the agglomeration among the components, with consequent improved mechanical characteristics.

Optional (i.e. that may be selected according to the requirements) component (F) is a powder of refractory clay that is based on hydrated aluminum silicate (Al₂O₃.4SiO₂.H₂O) and has surprisingly given the resin according to the invention, and the manufactured article, greater resistance to thermal and mechanical stresses.

Optional component (G) is a powder that comprises at least one water-repellent agent in solid form. Advantageously, the solid water-repellent agent is constituted by at least one alkyl alkoxysiloxane and has a density of preferably 280±50 grams/liter. This component has been found to give the article, even if in small percentages, a high degree of water repellency and waterproofness. The result is particularly conspicuous if ingredient (G) is paired with ingredient (E).

All of components (C), (D) and (E), moreover, allow to achieve and improve the water-repellency and waterproofness properties of the resin and accordingly of the finished article. The presence of even just one of them allows to achieve these properties, but the end result is particularly advantageous if all three are present simultaneously.

In a second aspect, the present invention relates to a method for producing a binding resin particularly for manufacturing articles, said method being characterized in that it comprises the step of mixing a powder that comprises silica and one or more hardening agents with a solution of at least one silicate of an alkaline metal.

All the characteristics of components (A) to (F) described with reference to the binding resin as such (in particular as regards the percentages of use and the chemical composition of the individual ingredients) are to be considered valid also for any embodiment of the method according to the invention.

As mentioned, according to a particularly advantageous embodiment, the method according to the invention provides for the separate mixing of all the solid components (i.e., (A) with (C), (D) and (G), if present), separately mixing the liquid component (B) with the other liquid component (F) if present, and mixing together the total solid and liquid components only at a later time.

It has in fact been found surprisingly that such a procedure (which is different from what is currently performed) allows to increase resistance to high temperatures and particularly avoids absolutely the formation of fumes following exposure of the resin to flames. For equal ingredients, it is not possible to achieve such an advantageous result if the mixing order now found is not followed.

According to another preferred embodiment, the method according to the invention is characterized in that it comprises the steps of:

(d) mixing the binding resin that comprises components (A) and (B) and optionally at least one component selected from the group that consists of components (C), (D), (E), (F) and (G) cited above with at least one inert material;

(e) pouring the mixture obtained from step (d) into a mold or form;

(f) curing the product.

Advantageously, all the optional ingredients cited above are mixed.

The term “inert material” is used to designate a compound that is capable of not interacting with the substances that surround it in the reaction and process conditions adopted in the present invention.

Inert materials are for example selected from the group that comprises pumice, perlite, expanded clay (of various particle sizes), vermiculite, polystyrene, straw, cork, kenaf, sawdust and wood derivatives (for example paper and cardboard), plastics and its derivatives, polyurethane (in any physical aspect or formulation thereof), aluminum, iron and metallic alloys, glass and its derivatives, rock, lava lapilli, carbon fiber, natural and/or synthetic fibers, textile fibers, metallic fibers, and mixtures thereof.

Advantageously, the inert material is mixed in an amount comprised between 10 and 70%, preferably between 15 and 35% by weight.

In a fully general way, according to the method of the invention, mixing step (d) is performed in a time comprised between 5 minutes and 3 hours, where the time required to achieve correct mixing depends on several different factors, such as for example the percentage quantity of reagents used, the operating temperature (summer/winter) and the corresponding degree of humidity, the type of inert material used (expanded clay, glass, perlite, pumice), et cetera.

Step (f), also termed article curing or drying step, can be performed in an extremely variable time, since it depends on several factors, such as the thickness of the article, the climate conditions, the operating conditions and others.

In particular, said time interval can vary between approximately 5 minutes and approximately 40 days, where the minimum time is achieved by using microwave technologies and the upper limit corresponds to a process in natural conditions (exposure to air).

By way of example, according to one embodiment the method according to the invention is characterized in that the step (f) for curing the product is extended for a time that is comprised between 20 and 40 days if performed in natural conditions.

According to another embodiment, the method according to the invention is characterized in that the product curing step (f) lasts 5 to 10 days if performed in a heated environment (dryer) with warm air at a temperature comprised between 40 and 70° C.

According to another embodiment, the method according to the invention is characterized in that the product curing step (f) lasts 10 to 30 minutes and more if it is performed in a high-pressure autoclave.

According to another embodiment, the method according to the invention is characterized in that the product curing step (f) lasts 5 to 20 minutes and more if performed with microwave technologies.

The time also varies according to the type of inert material used and according to the thickness and size of the article produced.

Regardless of the duration of step (f), according to a preferred embodiment the method is characterized in that the product curing step (f) is performed in the presence of CO₂ at 25° C., applied under pressure for a time that can vary between 5 and 30 minutes.

Further aspects of the present invention are constituted by a product that is manufactured starting from a binding resin according to any one of the embodiments described above and by a product according to the method of any of the embodiments described above.

Among the most important advantages achieved by the present invention, mention can be made of the exceptional resistance to high temperatures of the binding resin and of the articles, which remains unchanged over time and even after countless exposure to a flame. Furthermore, the articles manufactured according to the present invention are absolutely resistant to humidity.

Another advantage of the invention is the excellent thermal insulation and sound absorption power of the resin and of the articles and the total absence of fumes or gaseous emissions of the final articles when they are exposed to a flame.

Moreover, an article according to the present invention has excellent characteristics of dimensional stability and mechanical strength and can also be easily finished by means of plaster or with decorations of various kinds.

According to the invention, an article made of a binding resin according to the present invention can be used in the most disparate physical forms and for the most disparate technical applications.

In this regard, an article made of a binding resin according to the present invention can be shaped for example by means of conventional methods in the form of a panel, wall, cladding and in any shape and size that can be useful to meet the various industrial requirements.

The described binding resin is used in the building, naval, aeronautical, transportation and other sectors. For example, it can be used as an article for insulating roofs, for manufacturing raised floors, for producing mechanical parts having particular characteristics, for providing components for motors, as a protective and fireproof coating, for partitions and expendable walls, in the form of reinforcement frame or form in buildings, in the form of a binding agent for spreading or coupling, as a component of flame-retardant barriers for doors and bulkheads for vehicle and watercraft, as a filler component, for thermally insulating panels in refrigeration and conditioning systems, in refrigeration cells, for insulating claddings and the like, for soundproofing panels and in all industrial applications in which it is possible to utilize the characteristics of the present invention.

According to a particularly preferred embodiment, the strength characteristics of the finished article can be further improved by inserting in the article a reinforcement that can be constituted for example my metallic or synthetic nets, plastics, synthetic fibers or materials that are conventionally used to perform this function.

Other characteristics and advantages of the present invention will become better apparent from the description of the following preferred embodiments, which are meant exclusively as nonlimiting examples.

In a similar manner, although in the examples that follow and in the text only some preferred combinations of elements (A) to (G) are described explicitly, the person skilled in the art will realize immediately that any combination, obtained according to the modus operandi of the invention, of the two essential elements (A) and (B) with the other components described in the text, even if it is not mentioned specifically, is equally advantageous and preferred.

In the examples that follow, the following ingredients, found to be particularly suitable for the purposes of the invention, have been used:

(A) silica-based hardening powder, with the addition of one or more hardening agents, marketed under the trade name “Duplas” by the company F.lli Mazzon S.p.A., Schio (VI);

(C) a powder comprising at least one pozzolanic inorganic binding agents, marketed under the trade name “Phenil” by the company Baumit Italia S.p.A., San Vito al Tagliamento (PN);

(D) a micronized powder of pozzolanic binding agent with high specific surface area, marketed under the trade name “RTV” by the company AZ Tech S.r.l., Racconigi (CN);

(B) an aqueous solution of alkaline metal silicate, marketed under the trade name “Solumex” by the company F.lli Mazzon S.p.A., Schio (VI);

(E) a solution of waterproofer, marketed under the trade name “Prolhab” by the company Chem Spec S.r.l., Peschiera Borromeo (MI);

(F) a powder of refractory clay, marketed under the trade name “Varil” by the company F.lli Mazzon S.p.A., Schio (VI);

(G) a powder of solid water-repellent agent, marketed under the trade name “Carol B100” by the company Chem Spec S.r.l., Peschiera Borromeo (MI).

### EXAMPLE 1

A mixture was prepared (climate conditions: 23° C. ambient temperature, approximately 35% humidity) by mixing:

(A) silica-based hardening powder with the addition of one or more hardening agents, 65% by weight.

(B) solution of an alkaline metal silicate, 35% by weight.

The resulting mixture was cast into a mold to provide a panel with a thickness of 20 mm and dimensions of 150×150 mm, and curing and drying were performed, with consequent hardening of the binding resin by virtue or with the use of microwave technology (oven) at a temperature of approximately 100° C. for a period of approximately 2 hours. A decrease by approximately 20% of the weight was observed due to loss of moisture.

The resulting panel was tested and exhibited high mechanical strength (in particular torsional strength) as well as high hydrophobicity. The resulting panel is particularly light and floats on water.

### EXAMPLE 2

The following mixtures were prepared (climate conditions: 23° C. ambient temperature, approximately 35% humidity):

Mixture 2a

(A) silica-based hardening powder with the addition of one or more hardening agents, 45% by weight.

(B) solution of an alkaline metal silicate, 40% by weight.

(F) powder constituted by refractory clay based on aluminum silicate, 15% by weight.

Mixture 2b

(A) silica-based hardening powder with the addition of one or more hardening agents, 35% by weight.

(B) solution of an alkaline metal silicate, 45% by weight.

(C) powder comprising at least one pozzolanic inorganic binding agent, 10% by weight.

(D) pozzolanic binding agent with large specific surface area in the form of micronized powder, 10% by weight.

Mixture 2c

(A) silica-based hardening powder with the addition of one or more hardening agents, 50% by weight.

(B) solution of an alkaline metal silicate, 38% by weight.

(C) powder comprising at least one pozzolanic inorganic binding agent, 4% by weight.

(D) pozzolanic binding agent with large specific surface area in the form of micronized powder, 6.5% by weight.

(E) solution of a waterproofer, 1.5% by weight.

The resulting mixtures were cast into molds to provide panels with a thickness of 20 mm and dimensions of 150×150 mm, and curing and drying were performed, with consequent hardening of the binding resins by virtue or by the use of microwave technology (oven) or by means of a hot air drying system.

The hardened panels were tested and exhibited high mechanical strength (in particular torsional strength) as well as high hydrophobicity. Furthermore, depending on the composition, they also had excellent resistance to very high temperatures and a high thermal insulation and soundproofing power.

For resistance to very high temperatures, the panels were exposed to a flame with temperatures above 2000° C.

Furthermore, by way of the particular manufacturing process, the panels provided did not produce any fumes or gases during exposure to the flame.

All the resulting panels were particularly light and floated on water.

### EXAMPLE 5

A mixture was prepared (environment conditions: 23° C. ambient temperature, approximately 35% humidity) by mixing in the previously described order the following components:

(A) silica-based hardening powder with the addition of one or more hardening agents, 40% by weight.

(F) powder constituted by refractory clay based on aluminum silicate, 5% by weight.

(C) powder comprising at least one pozzolanic inorganic binding agent, 4% by weight.

(D) pozzolanic binding agent with large specific surface area in the form of micronized powder, 6% by weight.

(B) solution of an alkaline metal silicate, 23.4% by weight.

(E) solution of a waterproofer, 1.5% by weight.

(G) powder of a solid water-repellent agent based on alkyl alkoxysilane, 0.1% by weight.

Inert material: expanded clay (with particle size 5/8 mm), 20% by weight.

The resulting mixture was cast into a mold to provide an article, particularly a panel with a thickness of 30 mm and dimensions of 400×300 mm, and curing and drying were performed, with consequent hardening of the binding resin achieved by means of a hot air drying system at a temperature of 50° C. for a time interval that varies between 5 and 10 days, until complete drying and consequent hardening of the article was achieved.

The resulting article was tested and exhibited excellent resistance to very high temperatures and a high thermal insulation and soundproofing power, high mechanical strength (particularly torsional strength) and high resistance to hydrolysis. The resulting article is particularly light and floats on water.

For resistance to very high temperatures, the article was exposed to the flame with temperatures above 2000° C.

Furthermore, the article manufactured by exposure to the flame did not generate any kind of fume or gas.

### EXAMPLE 6

A mixture was prepared (climate conditions: 27° C. ambient temperature, approximately 40% relative humidity) by mixing in the previously described order the following components:

(A) silica-based hardening powder with the addition of one or more hardening agents, 18% by weight.

(F) powder constituted by refractory clay based on aluminum silicate, 8% by weight.

(C) powder of a mass additive, 4% by weight.

(D) micronized powder, 6% by weight.

(B) solution of an alkaline metal silicate, 37.4% by weight.

(E) solution of a waterproofer, 1.5% by weight.

(G) powder of a water-repellent agent based on alkyl alkoxysilane, 0.1% by weight.

Inert material: perlite, 25% by weight.

The resulting mixture was cast into a mold to provide an article, particularly a panel with a thickness of 30 mm and dimensions of 400×300 mm. Curing and drying were then performed, with consequent hardening of the mixture achieved by means of an oven at 120° C. for 2 to 5 days, until complete drying and consequent hardening of the article were achieved.

The resulting article was tested and exhibited excellent resistance to very high temperatures, high thermal insulation power, high mechanical strength (particularly torsional strength) and high resistance to hydrolysis. The resulting article is particularly light and floats on water and for an equal volume is even lighter than the product obtained in example 5.

Although only some preferred embodiments of the invention have been illustrated in the text, the person skilled in the art will understand immediately that it is in any case possible to obtain other embodiments that are equally advantageous and preferred and comprise other combinations, not cited explicitly, of the fundamental components (A) and (B) with the other components described in the text.

The disclosures in Italian Patent Application No. MI2003A002125 from which this application claims priority are incorporated herein by reference.

What is claimed is:

1-40. (canceled)

41. A binding resin particularly for manufacturing articles, comprising the following components:
(A) a powder that comprises silica and one or more hardening agents; and
(B) a solution of at least one silicate of an alkaline metal.

42. The binding resin according to claim 41, further comprising at least one of the following optional ingredients:
(C) a powder comprising at least one pozzolanic inorganic binding agent;
(D) a powder comprising at least one pozzolanic binding agent with large specific surface area;
(E) a solution comprising at least one waterproofer;
(F) a powder comprising refractory clay comprising aluminum silicate;
(G) a powder comprising at least one water-repellent agent in solid form.

43. The binding resin according to claim 41, further comprising at least one element for each one of the following groups:
Group (1): (A) a powder comprising silica and one or more hardening agents;
Group (2): (B) a solution of at least one silicate of an alkaline metal;
Group (3):
(C) a powder comprising at least one pozzolanic inorganic binding agent;
(D) a powder comprising at least one pozzolanic binding agent with large specific surface area; and
(E) a solution comprising at least one waterproofer;
Group (4): (F) a powder comprising refractory clay comprising aluminum silicate; and
Group (5): (G) a powder comprising at least one water-repellent agent in solid form.

44. The binding resin according to claim 42, further comprising all the ingredients (A) to (G).

45. The binding resin according to claim 41, further comprising the following components:
(A) a powder comprising silica and one or more hardening agents in an amount comprised between 15 and 85% by weight on the final weight of the mixture; and
(B) a solution of at least one silicate of an alkaline metal in an amount comprised between 15 and 85% by weight on the final weight of the mixture.

46. The binding agent according to claim 42, further comprising at least one of the following optional ingredients:
(C) a powder comprising at least one pozzolanic inorganic binding agent in an amount comprised between 4 and 10% by weight on the final weight of the mixture;
(D) a powder comprising at least one pozzolanic binding agent with high specific surface area, in an amount comprised between 5 and 15% by weight on the final weight of the mixture;
(E) a solution comprising at least one waterproofer in an amount comprised between 1 and 2% by weight on the final weight of the mixture;
(F) a powder comprising refractory clay, comprising aluminum silicate in an amount comprised between 5 and 40% by weight on the final weight of the mixture;
(G) a powder comprising at least one water-repellent agent in solid form in an amount comprised between 0.1 and 1% by weight on the final weight of the mixture.

47. The binding resin according to claim 41, wherein component (A) comprises 10 to 99.9% by weight of silica in powder form, mixed with an amount comprised between 0.1 and 20% by weight on the total of the powder of at least one hardening agent.

48. The binding resin according to claim 41, wherein the hardening agent is selected from the group that comprises polyhydroxyl alcohol esters and alkylene carbonate esters.

49. The binding resin according to claim 41, wherein in component (B) the solution is an aqueous solution.

50. The binding resin according to claim 41, wherein in component (B) said alkaline metal is selected from the group that comprises sodium, potassium and a mixture thereof.

51. The binding resin according to claim 50, wherein the aqueous solution of alkaline metal silicate has a weight ratio between SiO₂ and Na₂O comprised between 1.5:1 and 4.0:1 or a weight ratio between SiO₂ and K₂O comprised between 1.5:1 and 4.0:1.

52. The binding resin according to claim 42, wherein component (C) comprises at least one blast furnace slag.

53. The binding resin according to claim 52, wherein said blast furnace slag comprises calcium oxides in an amount of approximately 40% by weight, silica in an amount of approximately 30% by weight, and alumina in an amount of approximately 10% by weight, the quantities being variable according to the source material from which the slag is derived.

54. The binding resin according to claim 42, wherein component (D) is constituted by condensed silica fume.

55. The binding resin according to claim 54, wherein the condensed silica fume is an amorphous powder with spheroidal granules, a bulk density comprised in the range of 0.60+/−0.02 kg/l, and a specific surface area equal to, or greater than, 15 m²/g.

56. The binding resin according to claim 42, wherein the waterproofer in component (E) is constituted by a solution of at least one alkylsiliconate.

57. The binding resin according to claim 56, wherein said solution is an aqueous solution.

58. The binding resin according to claim 56, wherein said alkylsiliconate is present in an amount comprised between 1 and 3% by weight on the total weight of the mixture.

59. The binding resin according to claim 56, wherein said alkylsiliconate is potassium methylsiliconate.

60. The binding resin according to claim 42, wherein the solid water-repellent agent in ingredient (G) is constituted by at least one alkyl alkoxysiloxane.

61. A method for producing a binding resin particularly for manufacturing articles, comprising the step of mixing a powder that comprises silica and one or more hardening agents with a solution of at least one silicate of an alkaline metal.

62. The method according to claim 61, further comprising the additional steps of mixing ingredients (A) and (B) with at least one of the optional ingredients selected from the group that consists of (C), (D), (E), (F), and (G).

63. The method according to claim 62, wherein the solid ingredient (A) is mixed separately with all the optional solid components that are present and are selected from the group that consists of ingredients (C), (D) and (G) and mixtures thereof, in that the liquid component (B) is mixed separately with the other optional liquid component (F) if present, and the solid and liquid components are mixed together at a later time.

64. The method according to claim 63, wherein component (G), if present, is the first of the solid ingredients to be mixed with (A).

65. The method according to claim 63, further comprising the steps of:
(a) mixing a powder comprising silica and one or more hardening agents with a powder comprising at least one water-repellent agent in solid form;
(a1) mixing the product of step (a) with a powder comprising at least one pozzolanic inorganic binding agent;
(a2) mixing the product of step (a1) with a powder comprising at least one pozzolanic binding agent with high specific surface area;
(a3) mixing the product of step (a2) with a powder comprising refractory clay that comprises aluminum silicate;
(b) mixing a solution of at least one silicate of an alkaline metal with a solution that comprises at least one waterproofer; and
(c) mixing the product of step (a3) with the product of step (b).

66. The method according to claim 65, further comprising the steps of:
(d) mixing the binding resin obtained according to the method of claim 65 with at least one inert material;
(e) pouring the mixture obtained from step (d) into a mold or form;
(f) allowing the product to cure.

67. The method according to claim 66, wherein the inert material is used in an amount between 10 and 70% by weight.

68. The method according to claim 61, wherein the inert material is selected from the group that comprises pumice, perlite, expanded clay (of various particle sizes), vermiculite, polystyrene, straw, cork, kenaf, sawdust and wood derivatives (for example paper and cardboard), plastics and its derivatives, polyurethane (in any physical aspect or formulation thereof), aluminum, iron and metallic alloys, glass and its derivatives, rock, lava lapilli, carbon fiber, natural and/or synthetic fibers, textile fibers, metallic fibers, and mixtures thereof.

69. The method according to claim 66, wherein mixing step (d) lasts 5 minutes to 3 hours.

70. The method according to claim 66, wherein step (f) for curing the product lasts 5 minutes to 40 days.

71. The method according to claim 70, wherein step (f) for curing the product lasts 20 to 40 days if performed in natural conditions.

72. The method according to claim 70, wherein the step (f) for curing the product lasts 5 to 10 days if performed in a heated environment (dryer) with hot air at a temperature comprised between 40 and 70° C.

73. The method according to claim 70, wherein step (f) for curing the product lasts 10 to 30 minutes and more if performed in an autoclave at high pressure.

74. The method according to claim 70, wherein the step (f) for curing the product lasts 5 to 20 minutes and more if it is performed with microwave technologies.

75. The method according to claim 66, wherein the product curing step (f) is performed in the presence of CO₂ at 25° C., applied under pressure for a time that can vary from 5 to 30 minutes.

76. A product manufactured starting from a binding resin according to claim 41.

77. The product according to the method of claim 61.

78. The product of claim 76, further comprising internally a reinforcement constituted by at least one element selected among metallic nets, plastic nets, synthetic fibers and materials conventionally used to improve the strength characteristics of the article.

79. The article made from the binding resin of claim 41 suitable for building, naval, aeronautical and transportation sectors.

80. The article of claim 79, suitable for insulation of roofs, manufacture of raised floors, provision of mechanical parts having particular characteristics, provision of components for motors, manufacture of partitions and expendable walls, erection of buildings, manufacture of flameproof barriers for doors and bulkheads for vehicles and watercraft, manufacture of thermally insulating panels in refrigeration and conditioning systems, manufacture of refrigeration cells, manufacture of insulating claddings and the like, and manufacture of soundproofing panels.
